(19) United States
(12) Patent Application Publication
(10) Pub. No.: US 2025/0093870 A1
(43) Pub. Date: Mar. 20, 2025

(54) DETECTING AN UNUSUAL OPERATION OF A VEHICLE OUTSIDE OF A TIME FENCE

(71) Applicant: Caterpillar Inc., Peoria, IL (US)

(72) Inventors: Daniel Adler, Peoria, IL (US); Julie Gannon, Peoria, IL (US); Joshua Reed, Galesburg, IL (US)

(21) Appl. No.: 18/467,179

(22) Filed: Sep. 14, 2023

(51) Int. Cl. G05D 1/00

(52) U.S. Cl. CPC G05D 1/0022

(57) ABSTRACT

The disclosed system obtains a current time and a time fence indicating a daily time period and determines whether the current time is within the time fence. Upon determining that the current time is outside the time fence, the system operates the battery in a low-power mode, where the low-power mode is configured to conserve power associated with the battery. When the battery is in the low-power mode and the system detects an unusual operation associated with the vehicle, the system generates a notification of the unusual operation and sends the notification of the unusual operation to a server.

### BACKGROUND

Commercial vehicle theft is an enormous problem that affects many businesses and individuals. Heavy-duty vehicles, such as the ones used in construction, are expensive machines where an individual machine can cost up to a million dollars. According to the FBI, more than 40,000 commercial vehicles were stolen in the United States in 2019, resulting in losses of over $1 billion. Commercial vehicle theft can disrupt business operations, damage customer relationships, increase insurance costs, and expose sensitive information.

### SUMMARY

The disclosed system detects an unusual operation, such as a movement of the vehicle, outside of a time fence. The time fence indicates a daily time period and can be continuous, e.g., from 8 AM to 5 PM, or broken out into various noncontinuous periods, such as 8 AM to noon and 1 PM to 5 PM. The disclosed system can be a detachable unit that includes a radio, an accelerometer configured to detect motion, and a battery, and it can be mounted on a vehicle such as a heavy-duty vehicle used in construction. The detachable unit is sufficiently small to be imperceptible and can be placed in an inconspicuous location, such as underneath the vehicle, so that if an unauthorized party tries to move the vehicle, the unauthorized party cannot easily detect the presence of the detachable unit and remove the detachable unit from the vehicle.

### BRIEF DESCRIPTION OF THE DRAWINGS

Detailed descriptions of implementations of the present invention will be described and explained through the use of the accompanying drawings.

FIG. 1 shows a detachable unit coupled to a vehicle based on a time fence.

FIG. 2 shows the detachable unit in more detail.

FIG. 3 shows adjusting the frequency of communication between the detachable unit and a cell tower.

FIG. 4 is a flowchart of a method to detect an unusual operation of a vehicle outside of a time fence.

FIG. 5 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

### Detecting An Unusual Operation of a Vehicle Outside of a Time Fence

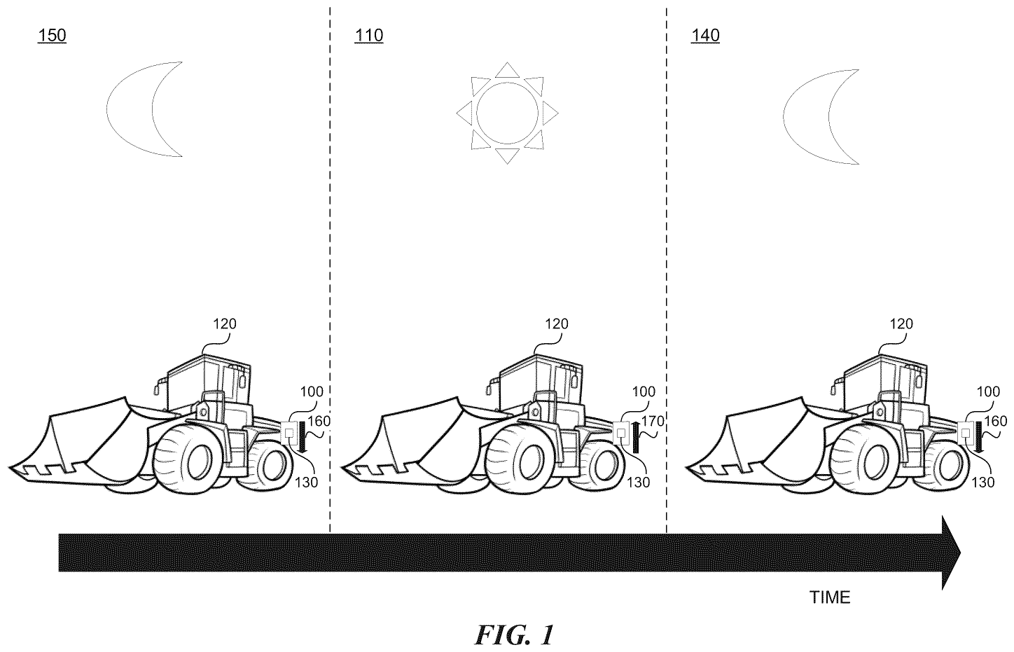

FIG. 1 shows a detachable unit 100 coupled to a vehicle 120 based on a time fence. The detachable unit 100 (described in more detail below) is a low-cost electronic device that can be coupled, e.g., attached and detached, to any vehicle 120 and can monitor the movement of the vehicle. The detachable unit 100 can be attached using various mechanisms such as tape, glue, hook and loop, magnets, etc. The detachable unit 100 is small in size, e.g., several millimeters in each dimension, and imperceptible, thus making it difficult for a potential thief to identify and remove. The vehicle 120 can be a heavy-duty vehicle specially designed to execute construction tasks, most frequently involving earthwork operations or other large construction tasks.

A time fence 110 is a daily time period during which the vehicle 120, such as heavy construction machinery, is configured to operate at a jobsite. The time fence 110 can be continuous, such as from 8 AM to 5 PM or 9 AM to 6 PM, or the time fence 110 can be discontinuous, such as from 8 AM to noon and 1 PM to 5 PM.

Outside of the time fence 110, such as during time periods 140, 150, the detachable unit 100 switches the battery 130 into a low-power mode 160. The time periods 140, 150 cover the time periods of the day that are outside of the time fence 110. In addition, the time periods 140, 150 can indicate when the vehicle 120 is in a scheduled downtime. The low-power mode 160 enables the battery 130 to preserve power and prolongs the battery life, which needs to last approximately 5 years. In the high-power mode 170, the detachable unit 100 consumes more power than when the detachable unit is in the low-power mode 160. The high-power mode 170 enables the detachable unit 100 to communicate with other nearby devices.

When the battery 130 is in the low-power mode 160, namely, during the time periods 140, 150, a vehicle monitor needs to know if/when the vehicle 120 has been moved at a time when it was not expected to be moved, e.g., after working hours or when the vehicle is supposed to be in a scheduled downtime. The detachable unit 100 can detect an unusual operation associated with the vehicle, such as a movement of the vehicle or powering up of the vehicle 120. When such an unusual operation is detected, the detachable unit 100 can switch to the high-power mode 170 and generate a notification of the unusual operation.

In addition, the detachable unit 100 can check whether the time at which the unusual operation is detected is close to the time fence 110, such as within half an hour of the time fence. If the time at which the unusual operation is detected is close to the time fence, the detachable unit 100 may not generate the notification because the operation of the vehicle 120 may start early or run late. For example, if the time fence 110 starts at 8 AM, and the vehicle is powered at 7:45 AM, the detachable unit 100 can determine that the operation of the vehicle is not unusual because the operation is so close to the time fence.

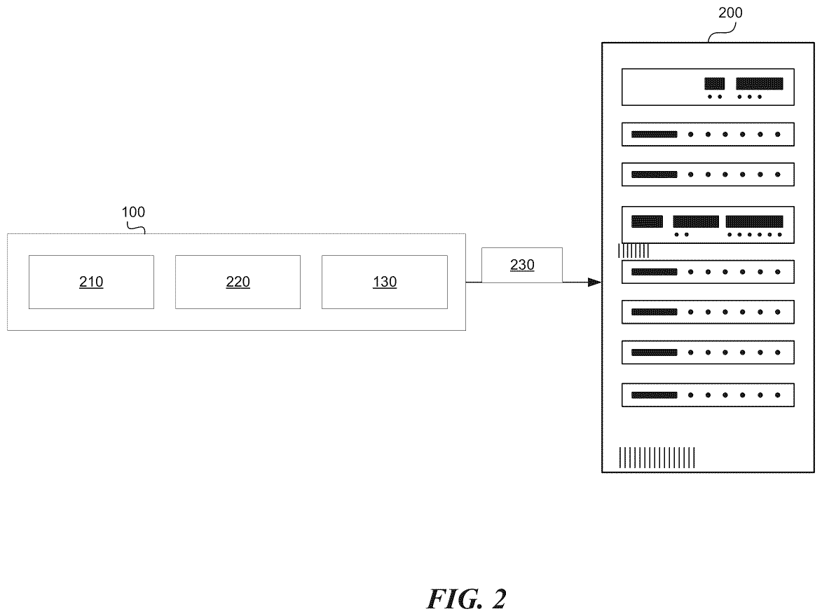

FIG. 2 shows the detachable unit 100 in more detail. The detachable unit 100 can be PL143 and can include an accelerometer 210, a communications interface 220, such as a radio, and a battery 130. The accelerometer 210 can be inside the communications interface 220. Typically, the detachable unit 100 is used to provide time and location information while the vehicle 120 in FIG. 1 is moving around during a normal workday. The detachable unit 100 is attached to the vehicle 120 in a concealed position.

The detachable unit 100 operates in high-power mode during the time fence 110 in FIG. 1 and switches into low-power mode outside of the time fence 110 to preserve power and battery life. Upon detecting an unusual movement of the accelerometer 210 outside the time fence 110 in FIG. 1, the detachable unit 100 can generate a notification 230 of the unusual movement and transmit the notification to a central server 200. The central server 200 can be a cloud server and can be configured to store the data received from multiple detachable units 100.

For example, the accelerometer 210 can detect movement and alert the communications interface 220. The communications interface 220 can determine whether the current time is outside of the time fence 110. Upon determining that the current time is outside of the time fence, the communications interface 220 can generate the notification 230 indicating the detected movement.

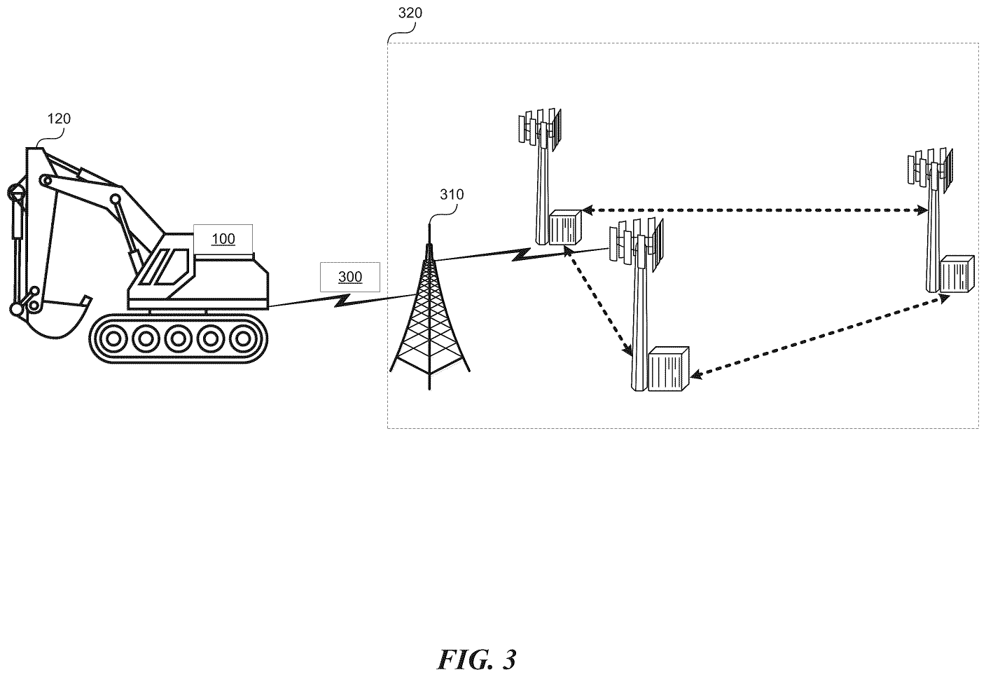

In addition, the detachable unit 100 can also monitor whether the location of the vehicle is inside a geofence. A geofence is a virtual perimeter for a real-world geographic area defined by global positioning system or radiofrequency identification technology that enables software to trigger a response when a mobile device enters or leaves a particular area. The geofence can be dynamically generated or match a predefined set of boundaries, such as a jobsite within which the vehicle is authorized to operate. The geofence can be continuous or broken into multiple noncontinuous regions. Once the vehicle leaves the geofence, the detachable unit 100 can generate a notification 230 and/or can increase the frequency of the communication 300, as described in FIG. 3 below.

FIG. 3 shows adjusting the frequency of communication between the detachable unit and a cell tower. While the detachable unit 100 is operating in the low-power mode 160 in FIG. 1, the detachable unit 100, e.g., the communications interface 220 in FIG. 2, can infrequently send a communication 300 to a cell tower 310, which is a part of a wireless telecommunication network 320. For example, in the low-power mode 160, the communication 300 may not be sent or can be sent every 4 hours. The communication 300, such as a message indicating the ID of the vehicle 120, can be used to locate the vehicle. The communication 300 can be an extended Discontinuous Reception (eDRX) message. The communication 300 can be sent less frequently while the vehicle 120 is operating in the low-power mode 160 to reduce battery consumption.

If the detachable unit 100 detects an unusual operation outside of the time fence 110 in FIG. 1, the detachable unit can switch to the high-power mode 170 in FIG. 1 and increase the frequency of the communications 300 sent to the cell tower 310. For example, the detachable unit 100 can increase the frequency of communications 300 to 10 times per minute. The frequency of communications 300 when in the high-power mode 170 can vary based on the value of the vehicle 120 to which the detachable unit 100 is attached. For example, the detachable unit 100 can receive an input indicating the frequency, where the input varies based on the value of the vehicle 120.

By receiving the communications 300 more frequently, the server 200 in FIG. 2 can more accurately track the location of the vehicle 120. Further, based on the frequent communications 300, the server 200 can determine when the vehicle 120 has stopped moving. The server 200 can notify authorities, such as the police, of the new location of the potentially stolen vehicle 120.

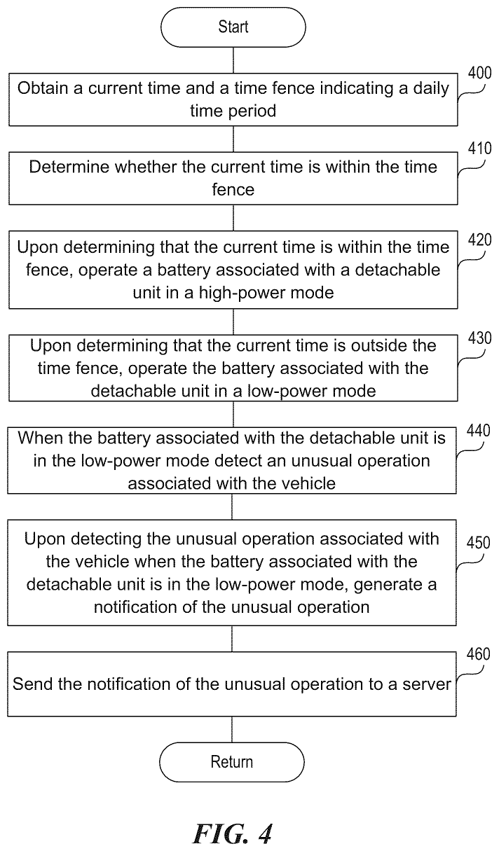

FIG. 4 is a flowchart of a method to detect an unusual operation of a vehicle outside of a time fence. A hardware or software processor executing instructions described in this application can, in step 400, obtain a current time and a time fence indicating a daily time period. The time fence can be continuous, e.g., from 8 AM to 5 PM, or broken out into various noncontinuous periods, such as 8 AM to noon and 1 PM to 5 PM. The hardware or the software processor can be associated with a detachable unit that includes a radio, an accelerometer configured to detect motion, and a battery.

In step 410, the processor can determine whether the current time is within the time fence. In step 420, upon determining that the current time is within the time fence, the processor can operate a battery associated with a detachable unit in a high-power mode, where the high-power mode is configured to enable a communication indicating a location associated with the vehicle. The detachable unit can be mounted on a vehicle.

In step 430, upon determining that the current time is outside the time fence, the processor can operate the battery associated with the detachable unit in a low-power mode, where the low-power mode is configured to conserve power associated with the battery and the battery life.

In step 440, when the battery associated with the detachable unit is in the low-power mode, the processor can detect an unusual operation associated with the vehicle. The unusual operation can include a movement associated with the vehicle occurring outside of the time fence.

In step 450, upon detecting the unusual operation associated with the vehicle when the battery associated with the detachable unit is in the low-power mode, the processor can generate a notification of the unusual operation. In step 460, the processor can send the notification of the unusual operation to a central server.

While operating the battery associated with the detachable unit in the low-power mode, the processor can reduce a frequency of communication between the detachable unit and a cell tower associated with the wireless telecommunication network. The communication can be configured to indicate a location associated with the vehicle by enabling the wireless telecommunication network to triangulate the position of the communication. In addition, the communication can include an ID associated with the vehicle. The reduced frequency of communication can be zero outside of the time fence or can occur up to four times when the vehicle is in the low-power mode.

Upon detecting the unusual operation associated with the vehicle outside of the time fence, the processor can increase the frequency of communication between the detachable unit and the cell tower associated with the wireless telecommunication network, thereby enabling more frequent tracking of the location of the vehicle. The more frequent communication can vary between once every half hour to 10 times per minute.

The frequency of the communication between the vehicle and the cell tower associated with the wireless telecommunication network can be positively correlated with the value of the vehicle. For example, the higher the value of the vehicle, the more frequent the communication. The detachable unit can receive an input indicating how frequently to communicate with the cell tower upon detecting an unusual operation outside of the time fence. When the value of the vehicle is low, the indicated frequency of communication can be once every half hour, while when the value of the vehicle is high, the indicated frequency of communication can be 10 times per minute.

Upon detecting the unusual operation associated with the vehicle when the battery associated with the detachable unit is in the low-power mode, the processor can determine whether the current time is within a predetermined time period to the time fence, such as within half an hour of the time fence. Upon determining that the current time is within the predetermined time period to the time fence, the processor can avoid generating the notification of the unusual operation. This operation can be useful right before the beginning of the workday or right after the end of the workday. Sometimes, the vehicle can start up a little bit earlier or a little bit later than scheduled, and in those cases, the processor avoids generating alerts.

### Industrial Applicability

The disclosed system detects an unusual operation, such as a movement of the vehicle, outside of a time fence. The time fence indicates a daily time period and can be continuous, e.g., from 8 AM to 5 PM, or broken out into various noncontinuous periods, such as 8 AM to noon and 1 PM to 5 PM. The disclosed system can be a detachable unit that includes a radio, an accelerometer configured to detect motion, and a battery, and it can be mounted on a vehicle such as a vehicle used in construction. The detachable unit is sufficiently small to be imperceptible and can be placed in an inconspicuous location, such as underneath the vehicle, so that when an unauthorized party tries to move the vehicle, the unauthorized party cannot easily detect the presence of the detachable unit and remove the detachable unit from the vehicle.

The system obtains a current time and the time fence indicating a daily time period. The system can determine whether the current time is within the time fence. Upon determining that the current time is within the time fence, the system operates a battery associated with the detachable unit in a high-power mode, where the high-power mode is configured to enable a communication indicating a location associated with the vehicle. Upon determining that the current time is outside the time fence, the system operates the battery associated with the detachable unit in a low-power mode, where the low-power mode is configured to conserve power associated with the battery and the battery life.

When the battery associated with the detachable unit is in the low-power mode, the system can detect an unusual operation associated with the vehicle. The unusual operation can include a movement associated with the vehicle occurring outside of the time fence. Upon detecting the unusual operation associated with the vehicle when the battery associated with the detachable unit is in the low-power mode, the system generates a notification of the unusual operation. The system sends the notification of the unusual operation to a server.

### Computer System

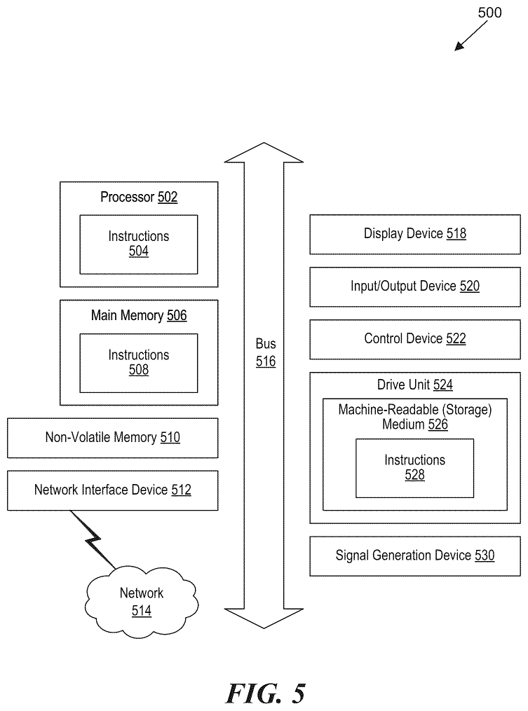

FIG. 5 is a block diagram that illustrates an example of a computer system 500 in which at least some operations described herein can be implemented. As shown, the computer system 500 can include: one or more processors 502, main memory 506, non-volatile memory 510, a network interface device 512, a display device 518, an input/output device 520, a control device 522 (e.g., keyboard and pointing device), a drive unit 524 that includes a storage medium 526, and a signal generation device 530 that are communicatively connected to a bus 516. The bus 516 represents one or more physical buses and/or point-to-point connections that are connected by appropriate bridges, adapters, or controllers. Various common components (e.g., cache memory) are omitted from FIG. 5 for brevity. Instead, the computer system 500 is intended to illustrate a hardware device on which components illustrated or described relative to the examples of the Figures and any other components described in this specification can be implemented.

The computer system 500 can take any suitable physical form. For example, the computer system 500 can share a similar architecture as that of a server computer, personal computer (PC), tablet computer, mobile telephone, game console, music player, wearable electronic device, network-connected (“smart”) device (e.g., a television or home assistant device), augmented reality/virtual reality (AR/VR) systems (e.g., head-mounted display), or any electronic device capable of executing a set of instructions that specify action(s) to be taken by the computer system 500. In some implementations, the computer system 500 can be an embedded computer system, a system-on-chip (SOC), a single-board computer system (SBC), or a distributed system such as a mesh of computer systems, or it can include one or more cloud components in one or more networks. Where appropriate, one or more computer systems 500 can perform operations in real time, in near real time, or in batch mode.

The network interface device 512 enables the computer system 500 to mediate data in a network 514 with an entity that is external to the computer system 500 through any communication protocol supported by the computer system 500 and the external entity. Examples of the network interface device 512 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 506, non-volatile memory 510, machine-readable medium 526) can be local, remote, or distributed. Although shown as a single medium, the machine-readable medium 526 can include multiple media (e.g., a centralized/distributed database and/or associated caches and servers) that store one or more sets of instructions 528. The machine-readable (storage) medium 526 can include any medium that is capable of storing, encoding, or carrying a set of instructions for execution by the computer system 500. The machine-readable medium 526 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 510, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 504, 508, 528) set at various times in various memory and storage devices in computing device(s). When read and executed by the processor 502, the instruction(s) cause the computer system 500 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense-that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

I/We claim:

1. A non-transitory, computer-readable storage medium storing instructions, which, when executed by at least one data processor of a system, cause the system to:
obtain a current time and a time fence indicating a daily time period;
determine whether the current time is within the time fence;
upon determining that the current time is within the time fence, operate a battery associated with a detachable unit in a high-power mode,
wherein the detachable unit is configured to be mounted on a vehicle,
wherein the high-power mode is configured to enable a communication indicating a location associated with the vehicle;
upon determining that the current time is outside the time fence, operate the battery associated with the detachable unit in a low-power mode,
wherein the low-power mode is configured to conserve power associated with the battery and battery life;
when the battery associated with the detachable unit is in the low-power mode, detect an unusual operation associated with the vehicle,
wherein the unusual operation includes a movement associated with the vehicle occurring outside of the time fence;
upon detecting the unusual operation associated with the vehicle when the battery associated with the detachable unit is in the low-power mode, generate a notification of the unusual operation; and
send the notification of the unusual operation to a server.

2. The non-transitory, computer-readable storage medium of claim 1, comprising instructions to:
while operating the battery associated with the detachable unit in the low-power mode, reduce a frequency of communication between the detachable unit and a cell tower associated with a wireless telecommunication network,
wherein the communication is configured to indicate a location associated with the vehicle.

3. The non-transitory, computer-readable storage medium of claim 1, comprising instructions to:
while operating the battery associated with the detachable unit in the low-power mode, reduce a frequency of communication between the detachable unit and a cell tower associated with a wireless telecommunication network,
wherein the communication is configured to indicate a location associated with the vehicle; and
upon detecting the unusual operation associated with the vehicle outside of the time fence, increase the frequency of communication between the detachable unit and the cell tower associated with the wireless telecommunication network, thereby enabling more frequent tracking of the location of the vehicle.

4. The non-transitory, computer-readable storage medium of claim 1, comprising instructions to:
upon detecting the unusual operation associated with the vehicle when the battery associated with the detachable unit is in the low-power mode, determine whether the current time is within a predetermined time period to the time fence; and
upon determining that the current time is within the predetermined time period to the time fence, avoid generating the notification of the unusual operation.

5. The non-transitory, computer-readable storage medium of claim 1, wherein the detachable unit includes a radio, an accelerometer configured to detect the unusual operation, and the battery.

6. The non-transitory, computer-readable storage medium of claim 1, comprising instructions to:
while operating the battery associated with the detachable unit in the low-power mode, reduce a frequency of communication between the vehicle and a cell tower associated with a wireless telecommunication network,
wherein the communication is configured to indicate a location associated with the vehicle; and
upon detecting the unusual operation associated with the vehicle outside of the time fence, increase a frequency of the communication between the vehicle and the cell tower associated with the wireless telecommunication network, thereby enabling more frequent tracking of the location of the vehicle,
wherein the frequency of the communication between the vehicle and the cell tower associated with the wireless telecommunication network is positively correlated with a value of the vehicle.

7. The non-transitory, computer-readable storage medium of claim 1, comprising instructions to:
while operating the battery associated with the detachable unit in the low-power mode, reduce a frequency of communication between the detachable unit and a cell tower associated with a wireless telecommunication network,
wherein the communication is configured to indicate a location associated with the vehicle; and
upon detecting the unusual operation associated with the vehicle outside of the time fence, increase the frequency of communication between the detachable unit and the cell tower associated with the wireless telecommunication network up to 10 times per minute, thereby enabling more frequent tracking of the location of the vehicle.

8. A method comprising:
obtaining a current time and a time fence indicating a daily time period;
determining whether the current time is within the time fence;
selectively operating a battery in a high-power mode or operating the battery in a low-power mode based on determining that the current time is within the time fence, or not, respectively,
wherein the low-power mode is configured to conserve power associated with the battery,
wherein the battery is associated with a detachable unit configured to be mounted on a vehicle;
when the battery is in the low-power mode, detect an unusual operation associated with the vehicle;
upon detecting the unusual operation associated with the vehicle when the battery is in the low-power mode, generating a notification of the unusual operation; and
sending the notification of the unusual operation to a server.

9. The method of claim 8, comprising:
while operating the battery associated with the detachable unit in the low-power mode, reducing a frequency of communication between the detachable unit and a cell tower associated with a wireless telecommunication network, wherein the communication is configured to indicate a location associated with the vehicle.

10. The method of claim 8, comprising:
while operating the battery associated with the detachable unit in the low-power mode, reducing a frequency of communication between the detachable unit and a cell tower associated with a wireless telecommunication network,
wherein the communication is configured to indicate a location associated with the vehicle; and
upon detecting the unusual operation associated with the vehicle outside of the time fence, increasing the frequency of communication between the detachable unit and the cell tower associated with the wireless telecommunication network, thereby enabling more frequent tracking of the location of the vehicle.

11. The method of claim 8, wherein the detachable unit includes a radio, an accelerometer configured to detect the unusual operation, and the battery.

12. The method of claim 8, comprising:
while operating the battery associated with the detachable unit in the low-power mode, reducing a frequency of communication between the vehicle and a cell tower associated with a wireless telecommunication network, wherein the communication is configured to indicate a location associated with the vehicle; and
upon detecting the unusual operation associated with the vehicle outside of the time fence, increasing a frequency of the communication between the vehicle and the cell tower associated with the wireless telecommunication network, thereby enabling more frequent tracking of the location of the vehicle, wherein the frequency of the communication between the vehicle and the cell tower associated with the wireless telecommunication network is positively correlated with a value of the vehicle.

13. The method of claim 8, comprising:
while operating the battery associated with the detachable unit in the low-power mode, reducing a frequency of communication between the detachable unit and a cell tower associated with a wireless telecommunication network, wherein the communication is configured to indicate a location associated with the vehicle; and
upon detecting the unusual operation associated with the vehicle outside of the time fence, increasing the frequency of communication between the detachable unit and the cell tower associated with the wireless telecommunication network up to 10 times per minute, thereby enabling more frequent tracking of the location of the vehicle.

14. A system comprising:
a detachable unit configured to be coupled to a vehicle,
the detachable unit including a battery, at least one hardware processor, and at least one non-transitory memory storing instructions, which, when executed by the at least one hardware processor, cause the system to:
obtain a current time and a time fence indicating a daily time period;
determine whether the current time is within the time fence;
upon determining that the current time is within the time fence, operate the battery in a high-power mode;
upon determining that the current time is outside the time fence, operate the battery in a low-power mode,
wherein the low-power mode is configured to conserve power associated with the battery;
when the battery is in the low-power mode, detect an unusual operation associated with the vehicle;
upon detecting the unusual operation associated with the vehicle when the battery is in the low-power mode, generate a notification of the unusual operation; and
send the notification of the unusual operation to a server.

15. The system of claim 14, comprising instructions to:
while operating the battery associated with the detachable unit in the low-power mode, reduce a frequency of communication between the detachable unit and a cell tower associated with a wireless telecommunication network,
wherein the communication is configured to indicate a location associated with the vehicle.

16. The system of claim 14, comprising instructions to:
while operating the battery associated with the detachable unit in the low-power mode, reduce a frequency of communication between the detachable unit and a cell tower associated with a wireless telecommunication network,
wherein the communication is configured to indicate a location associated with the vehicle; and
upon detecting the unusual operation associated with the vehicle outside of the time fence, increase the frequency of communication between the detachable unit and the cell tower associated with the wireless telecommunication network, thereby enabling more frequent tracking of the location of the vehicle.

17. The system of claim 14, comprising instructions to:
upon detecting the unusual operation associated with the vehicle when the battery associated with the detachable unit is in the low-power mode, determine whether the current time is within a predetermined time period to the time fence; and
upon determining that the current time is within the predetermined time period to the time fence, avoid generating the notification of the unusual operation.

18. The system of claim 14, wherein the detachable unit includes a radio, an accelerometer configured to detect the unusual operation, and the battery.

19. The system of claim 14, comprising instructions to:
while operating the battery associated with the detachable unit in the low-power mode, reduce a frequency of communication between the vehicle and a cell tower associated with a wireless telecommunication network,
wherein the communication is configured to indicate a location associated with the vehicle; and
upon detecting the unusual operation associated with the vehicle outside of the time fence, increase a frequency of the communication between the vehicle and the cell tower associated with the wireless telecommunication network, thereby enabling more frequent tracking of the location of the vehicle,
wherein the frequency of the communication between the vehicle and the cell tower associated with the wireless telecommunication network is positively correlated with a value of the vehicle.

20. The system of claim 14, comprising instructions to:
while operating the battery associated with the detachable unit in the low-power mode, reduce a frequency of communication between the detachable unit and a cell tower associated with a wireless telecommunication network,
wherein the communication is configured to indicate a location associated with the vehicle; and
upon detecting the unusual operation associated with the vehicle outside of the time fence, increase the frequency of communication between the detachable unit and the cell tower associated with the wireless telecommunication network up to 10 times per minute, thereby enabling more frequent tracking of the location of the vehicle.
